(19) United States
(12) Patent Application Publication
(10) Pub. No.: US 2018/0008094 A1
(43) Pub. Date: Jan. 11, 2018

(54) Outdoor Patio Equipment Cover With Photographic Background Landscape

(71) Applicant: Linda B. Mackinder, Charlevoix, MI (US)

(72) Inventor: Linda B. Mackinder, Charlevoix, MI (US)

(21) Appl. No.: 15/618,290

(22) Filed: Jun. 9, 2017

Related U.S. Application Data
(60) Provisional application No. 62/359,278, filed on Jul. 7, 2016.

(51) Int. Cl. A47J 37/07

(52) U.S. Cl. CPC A47J 37/0786

(57) ABSTRACT

A cover for a grill or similar piece of patio equipment, the cover having a front side or panel imprinted with a full-size photographic landscape image of an actual landscape matching the grill's background storage landscape in a typical patio location.

### RELATED APPLICATIONS/PRIORITY BENEFIT CLAIM

This application claims the benefit of U.S. Provisional Application No. 62/359,278 filed Jul. 7, 2016 by the same inventor (Mackinder), the entirety of which provisional application is hereby incorporated by reference.

### FIELD

The subject matter of the present application is in the field of soft fabric covers for outdoor patio equipment and furniture.

### BACKGROUND

Patio equipment such as charcoal and gas grills is commonly protected with a soft fabric waterproof cover when not in use. The cover is typically made from plain, neutral colored fabric (black, gray, tan) for easy cleaning and to minimize its appearance, which is at best utilitarian.

Some prior grill covers are provided with decorative touches such as sports team or manufacturer logos. For hunting enthusiasts there are grill covers in popular camouflage patterns.

Whether plain, logo-bearing, or camouflaged, prior grill covers generally disrupt the tranquil visual aspect of a patio or deck, which is usually sited to take advantage of a scenic landscape or view.

### BRIEF SUMMARY

I have invented a cover for grills and other large types of patio equipment and furniture (patio heaters, fire pits, tables, benches, etc., hereafter generally “grill” unless specified). The inventive cover comprises a more or less flat front side or panel when draped over the grill, the front side printed with a photographic landscape image of a natural scenic view or landscape chosen to match or complement the background landscape of the covered grill in its storage location. The photographic landscape image is an actual view of a real landscape or scenery, and not a mere stylized or artistic rendition or a pattern of disruptive colors and shapes as found in camouflage patterns.

In a preferred form, the photographic landscape image on the grill cover is matched approximately to the local grill background landscape, and may be varied according to local season, for example with two or more different covers matching two or more different seasons.

In a further form, the photographic landscape image on the grill cover is based on a photograph of the actual background landscape of the covered grill as viewed from a spot on or near the deck or patio; i.e., a custom photo of the user's view of the background behind the stored grill from an angle at which the covered grill is seen in everyday life.

In still a further form, a different photographic landscape image is applied to different sides of the grill cover, to complement or match the background landscape of the covered grill as viewed from different sides or angles at a given location.

“Printed” is used herein to mean any known process for printing or applying photographic images onto fabric materials, such as digital textile printing, or direct-to-garment (DTG) printing using software driven inkjet systems that convert photographs to prints.

“Landscape” is used herein to mean any natural, real-world environmental view of macro or discrete scenery features, whether part of a woods, field, skyline, shoreline, waterscape, etc., as opposed to micro or close-up views of small, random or repeated portions of some environmental feature such as portions of foliage like that used for some camouflage patterns. The landscape may include, in part or entirety, manmade elements such as buildings—farm buildings, fences, city blocks, building siding or facades, cosmopolitan skylines, gardens, etc.

“Patio” is used herein to mean not only patios and decks, but any near-house location where a grill or equivalent piece of outdoor equipment or furniture is frequently within view from near or inside the house.

These and other features and advantages of the invention will become apparent from the detailed description below, in light of the accompanying drawings.

### BRIEF DESCRIPTION OF THE DRAWINGS

FIG. 1 is a front view of a grill protected with a cover according to the invention, shown on a patio or deck with a first grill background landscape behind it and a complementary photographic landscape image on the front side of the cover.

FIG. 2 is an exploded view of alternate, modified covers shown exploded from the grill.

FIG. 3 is a perspective side view of the grill cover of FIG. 1, showing a different photographic landscape image complementary to a second grill background landscape viewed from a different side, the image applied to a flat opposite side panel of the grill cover.

FIG. 4 is similar to FIG. 1, but schematically represents a custom-matched photographic landscape image of the actual grill background landscape applied to the front side of the cover to match the actual grill background landscape behind the grill.

FIG. 5 is similar to FIGS. 1 and 4, but shows a modified grill cover with structured upper corners or ends to improve the flatness of the front side of the cover and the photographic landscape image displayed thereon.

### DETAILED DESCRIPTION

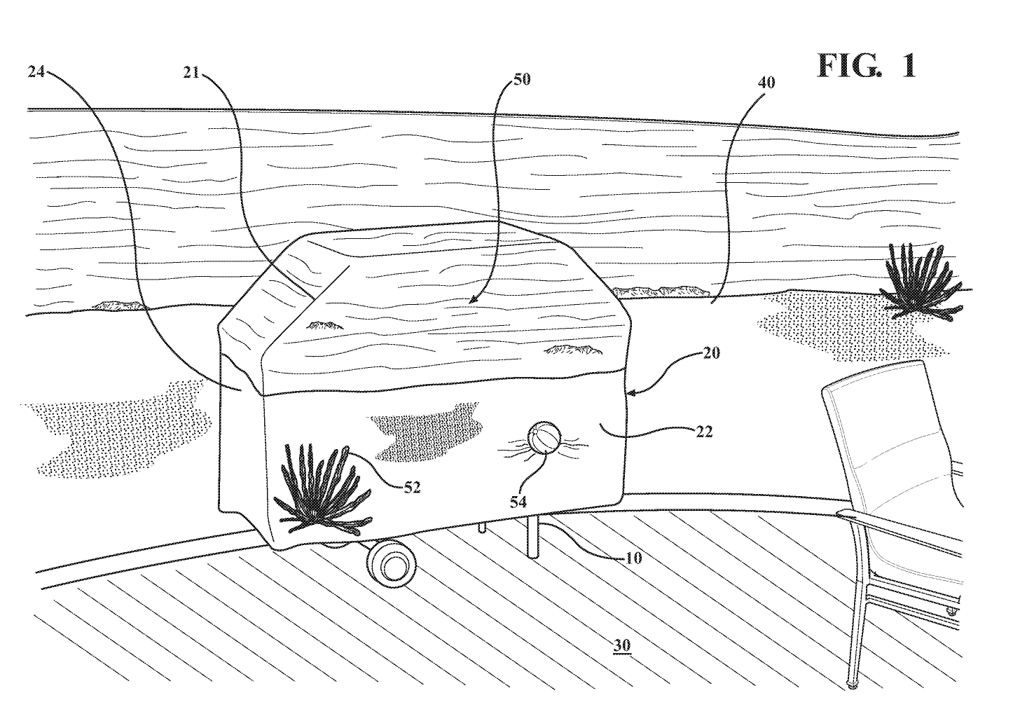

Referring first to FIG. 1, a barbecue grill 10 is shown covered with an exemplary fabric grill cover 20 in order to teach how to make and use the claimed invention. Grill 10 is shown located in a typical patio location 30 from the viewpoint of an adjacent house or building (not depicted in FIG. 1). Patio location 30 may be a patio, deck, or any convenient spot in the backyard to place a grill, without limitation. The view behind the grill 10 from the vantage point of FIG. 1, usually from inside or near the house, comprises the background landscape 40. In the illustrated example, the “backyard” relative to patio 30 is a waterfront and accordingly presents a waterfront background landscape.

Structurally, grill cover 20 is a conventional cover, made for example from a UV-resistant waterproof polyester or nylon canvas, although other conventional weather-resistant cover fabrics or fabric-like materials can be used. Cover 20 includes a front side or panel 22 that is generally or more-or-less flat when draped over grill 10, although some wrinkling or irregularity is normal given the drape of the fabric over a typical grill whose front face is not perfectly flat, and whose dimensions may be less than perfectly rectangular or regular. Front panel 22 and the other sides or panels of cover 20 may be delineated by welts or seams 21 formed during manufacture to joint multiple pieces of fabric or to add structure or shape to the soft fabric.

Front panel 22 of cover 20 is printed with a photographic landscape image 50 of a type similar or complementary to actual background landscape 40. In FIG. 1, grill cover photographic landscape image 50 is a waterfront landscape chosen for its similarity to actual background landscape 40. Photographic landscape image 50 is a printed representation of a photographic image of an actual, real landscape, made using known photograph-to-fabric image printing techniques.

Although at least the front panel 22 of cover 20 should be fully covered with photographic landscape image 50, FIG. 1 shows photographic landscape 50 applied in continuous fashion to the cover's side panels 24, as well. This provides a wraparound visual effect that makes grill cover 20 blend into or complement the actual background landscape 40 from different angles on patio 30.

It should be noted that photographic landscape image 50 may include both natural and manmade features, such as shown at 52 and 54, respectively, in FIG. 1. Alternately, photographic landscape image 50 may include only manmade features complementing a natural background landscape 40 (for example, a photographic image of a beach cabana or a boat to complement the natural background landscape 40 of a beach or waterfront); or, only natural features complementing a manmade landscape background 40 (for example, a photographic image of a shrub, hedge, lawn, tree, etc. to complement a wall of a building).

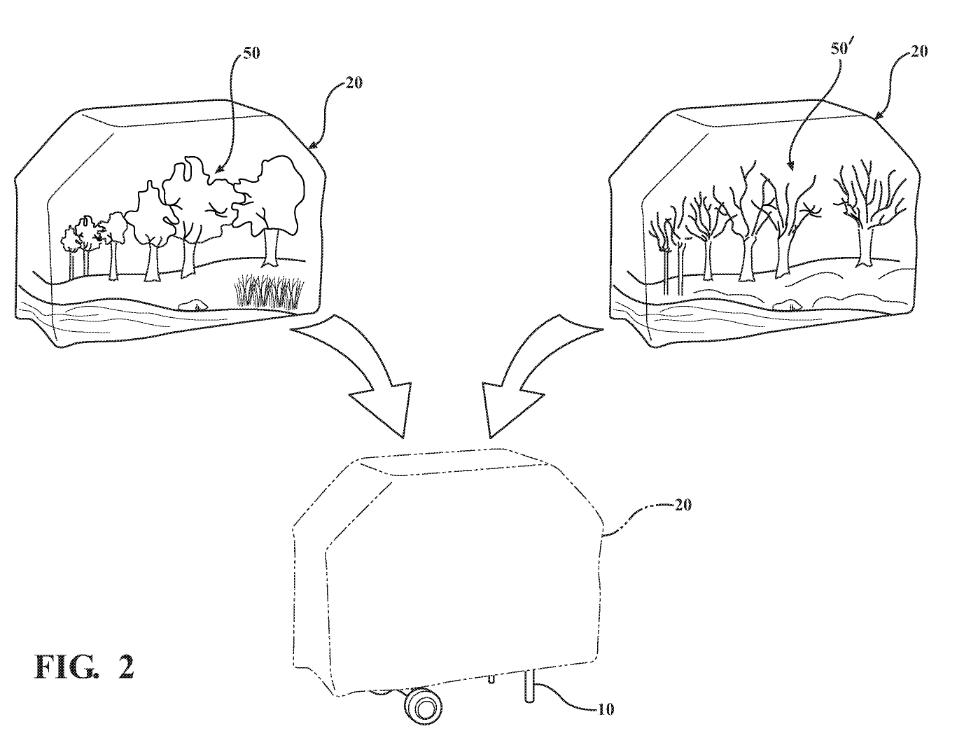

Referring next to FIG. 2, grill covers 20 with photographic landscape images 50 and 50′ representing different seasons are shown relative to a grill 10. Cover 20 with photographic landscape image 50 shows, for example, a summer scene of a particular landscape. Cover 20 with photographic landscape 50′ shows, for example, the same landscape in winter. A homeowner can accordingly purchase multiple covers 20 and apply them as needed to grill 10 as the seasons change.

Alternately, and still referring to FIG. 2, photographic landscapes 50 and 50′ could represent different complementary landscapes for different grill locations 30.

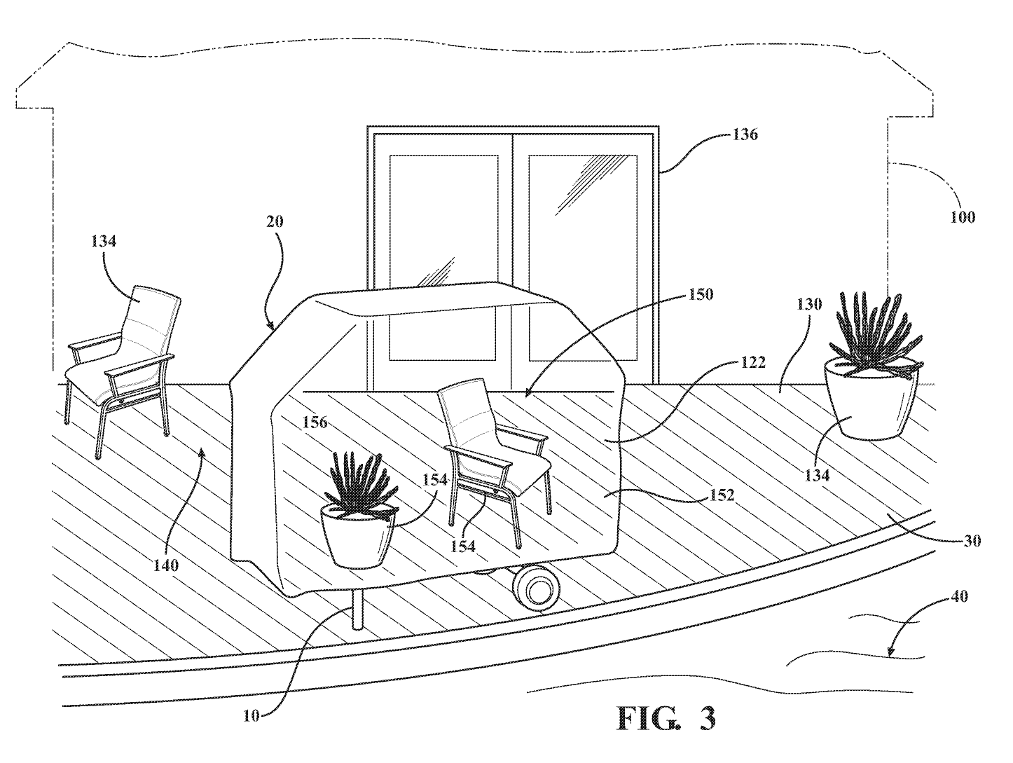

Referring to FIG. 3, cover 20 is shown over grill 10 in patio location 30 from the opposite viewpoint of FIG. 1, i.e. looking at house 100 from the viewpoint of the waterfront background landscape. A different photographic landscape image 150 is shown on the rear panel or side 122 of cover 20, complementary to the opposite grill background landscape 140 comprising portions of patio 30 and a side of house 100. Photographic landscape image 150 accordingly comprises image 152 of actual patio decking 130, images 154 of actual patio objects 134, and an image 156 of actual house exterior siding or features 136.

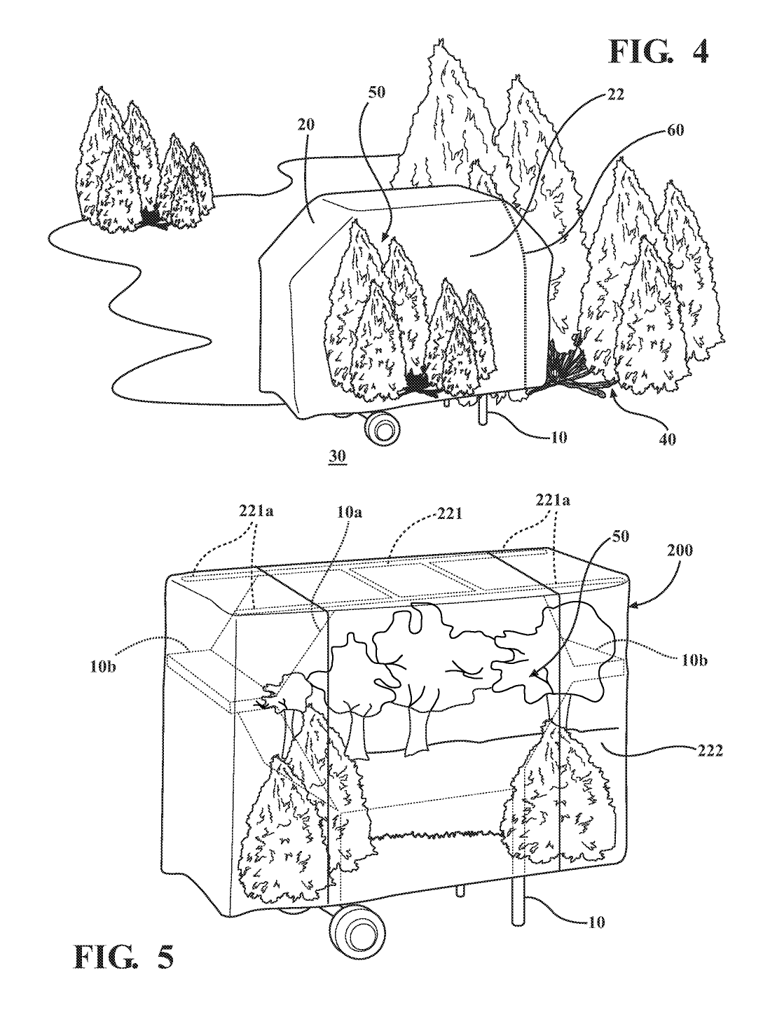

Referring now to both FIGS. 3 and 4, another aspect of the invention is the ability to custom match the photographic landscape image 50 (or 150) on one or more sides or panels of cover 20 to match the actual background landscape 40 (or 140) behind grill 10 from a particular viewpoint in patio location 30. In FIG. 3, photographic landscape image 150 on the back panel 122 of cover 20 may be a photographic image of the actual patio and house exterior features 132, 134, 136 of patio location 30 and house 100 custom printed onto cover 20. In FIG. 4, cover 20 has a front-panel photographic landscape image 50 comprising an actual photo of wooded background landscape 40 behind it, for a near-perfect visual match.

FIG. 4 also shows a zipper option 60 along one of the seams of cover 20, for example a heavy-duty YKK type zipper of the type used on tents, boat covers, and the like. Zipper 60 makes cover 20 easier to put on and take off the grill 10. By placing zipper 60 on a side panel 24 or along a seam between adjacent sides or panels, visual disruption of photograph landscape image 50 is minimized.

Referring to FIG. 5, a modified cover 200 with an improved front panel 222 is shown over the same grill 10 as in previous Figures. Cover 200, like cover 20, has a photographic landscape image 50 complementary to or matching the background landscape (not shown). Front panel 222 has been improved in terms of flatness and visual presentation of image 50 with a set of internal struts or similar rigidifying supports 221 secured to the inside of the cover. Struts 221 extend from a point of resting contact with the uppermost center portion 10a of grill 10 to free cantilevered ends 221a out over the grill's side portions 10b, which are often lower and give the grill a non-rectangular front outline that causes the fabric of any cover to sag at the sides. Struts 221 accordingly maintain the rectangular shape of the front panel 222 for an optimally flat, undistorted presentation of photographic landscape image 50.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been used to describe new and useful improvements in science and the useful arts. The scope of the invention supported by the above disclosure should accordingly be construed within the scope of what it teaches and suggests to those skilled in the art, and within the scope of any claims that the above disclosure supports in this application or in any other application claiming priority to this application.

1. A cover for a grill or similar patio equipment in a patio storage location, comprising:
a soft fabric cover configured to be draped over a grill or similar patio equipment, the cover including a front side or panel configured to be more or less flat when draped over a grill or similar patio equipment, the front panel printed with and substantially covered by a photographic landscape image selected to match or complement the background landscape of a grill or similar patio equipment in its patio storage location from a first patio location viewpoint.

2. The cover of claim 1, wherein the cover includes an opposite rear side or panel when draped over a grill or similar patio equipment, the rear panel printed with a second photographic landscape image selected to match or complement a second background landscape of a grill or similar patio equipment in its patio storage location from a second, opposite patio location viewpoint.

3. The cover of claim 1, wherein the photographic landscape image on the front panel of the cover consists of a photographic image of natural landscape features.

4. The cover of claim 1, wherein the photographic landscape image on the front panel of the cover consists of a photographic image of manmade landscape features.

5. The cover of claim 1, wherein the photographic landscape image on the front panel of the cover comprises both natural and manmade landscape features.

6. The cover of claim 1, wherein the cover comprises a first cover comprising a first photographic landscape image on its front panel and a second cover comprising a second photographic landscape image on its front panel, and wherein the second photographic landscape image is of the landscape in the first photographic landscape image in a different season.

7. In combination with a grill or similar patio equipment in a patio storage location, a grill cover comprising:
a soft fabric cover draped over the grill or similar patio equipment, the cover including a more or less flat front side or panel substantially covering a front of the grill or similar patio equipment, the front panel printed with and substantially covered by a photographic landscape image selected to match or complement a background landscape of the grill or similar patio equipment in the patio storage location from a first patio location viewpoint.

8. The combination of claim 7, wherein the photographic landscape image on the front panel of the grill cover is a photographic image of an actual grill background landscape of the grill in the patio storage location as viewed the first patio location viewpoint.
